(19) United States
(12) Patent Application Publication
(10) Pub. No.: US 2022/0329385 A1
(43) Pub. Date: Oct. 13, 2022

(54) Multiple Scrambling Identities Configuration

(71) Applicant: Lenovo (Beijing) Limited, Beijing (CN)

(72) Inventors: Bingchao Liu, Changping District (CN); Chenxi Zhu, Haidian District (CN); Lianhai Wu, Chaoyang (CN); Lingling Xiao, Haidian District (CN)

(73) Assignee: Lenovo (Beijing) Limited, Beijing (CN)

(21) Appl. No.: 17/630,858

(22) PCT Filed: Aug. 2, 2019
(86) PCT No.: PCT/CN2019/099011

§ 371 Date: Jan. 27, 2022

(51) Int. Cl. H04L 5/00

(52) U.S. Cl. CPC H04L 5/0053

(57) ABSTRACT

Methods and apparatuses for configuring multiple scrambling IDs for DL transmissions from multiple TRPs are disclosed. A method comprises grouping CORESETs into two or more CORESET groups, each CORESET group includes one or more CORESETs; and configuring the same number as the number of the CORESET groups of scrambling IDs associated with two or more CORESET groups.

### FIELD

The subject matter disclosed herein generally relates to wireless communications, and more particularly relates to configuring multiple scrambling IDs.

### BACKGROUND

The following abbreviations are herewith defined, at least some of which are referred to within the following description: Third Generation Partnership Project (3GPP), European Telecommunications Standards Institute (ETSI), Frequency Division Duplex (FDD), Frequency Division Multiple Access (FDMA), Long Term Evolution (LTE), New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), Personal Digital Assistant (PDA), User Equipment (UE), Uplink (UL), Evolved Node B (eNB), Next Generation Node B (gNB), New Radio (NR), Downlink (DL), Central Processing Unit (CPU), Graphics Processing Unit (GPU), Field Programmable Gate Array (FPGA), Dynamic RAM (DRAM), Synchronous Dynamic RAM (SDRAM), Static RAM (SRAM), Liquid Crystal Display (LCD), Light Emitting Diode (LED), Organic LED (OLED), Next Generation Node B (gNB), Orthogonal Frequency Division Multiplexing (OFDM), Radio Resource Control (RRC), Reference Signal (RS), Time-Division Duplex (TDD), Time Division Multiplex (TDM), User Entity/Equipment (Mobile Terminal) (UE), Uplink (UL), Universal Mobile Telecommunications System (UMTS), Internet-of-Things (IoT), Narrowband Internet-of-Things (NB-IoT or NBIoT), Long Term Evolution (LTE), Narrowband (NB), Physical Downlink Shared Channel (PDSCH), Physical Uplink Shared Channel (PUSCH), Downlink control information (DCI), Resource Block (RB), Physical Resource Block (PRB), Universal Mobile Telecommunications System (UMTS), Evolved-UMTS Terrestrial Radio Access (E-UTRA or EUTRA), Transmission Reception Point (TRP), Control Resource Set (CORESET), Hybrid Automatic Repeat reQuest (HARQ).

In Release 15, a UE can only communicate with one TRP. The UE is configured with a PDSCH scrambling ID used for PDSCH scrambling for interference randomization. When the UE receives PDSCH(s) scrambled by a sequence initialized with the PDSCH scrambling ID, the UE descrambles the received PDSCH(s) with the same sequence initialized with the PDSCH scrambling ID. In Release 16, different TRPs can simultaneously transmit multiple DCIs to schedule multiple PDSCHs transmitted in one slot. In order to random the inter-TRP interference, it has been agreed that the gNB could configure multiple scrambling IDs to generate different PDSCH scrambling sequences for one UE.

It is therefore an object of the present invention to provide methods and apparatuses to implement the configuration and the association between TRPs and scrambling IDs for DL transmissions from multiple TRPs.

### BRIEF SUMMARY

Methods and apparatuses for configuring multiple scrambling IDs for DL transmissions from multiple TRPs are disclosed.

In one embodiment, a method comprises grouping CORESETs into two or more CORESET groups, each CORESET group includes one or more CORESETs; and configuring the same number as the number of the CORESET groups of scrambling IDs associated with two or more CORESET groups.

In one embodiment, the CORESET(s) having the same index value are grouped into the same CORESET group.

In another embodiment, the CORESET(s) transmitted from the same TRP are grouped into the same CORESET group.

In some embodiment, the method further comprises scrambling PDSCH(s) scheduled by DCI(s) transmitted in the CORESETs in a CORESET group with a scrambling sequence initialized with the scrambling ID associated with the CORESET group.

In some embodiment, the method further comprises transmitting the scrambled PDSCH(s).

In one embodiment, a method comprises receiving scrambled PDSCH(s) scheduled by DCI(s) transmitted from CORESET(s) in a CORESET group; and descrambling the scrambled PDSCH(s) with a scrambling sequence initialized with a scrambling ID associated with the CORESET group.

In another embodiment, a base unit comprises a processor that groups CORESETs into two or more CORESET groups, wherein each CORESET group includes one or more CORESETs; and configures the same number as the number of the CORESET groups of scrambling IDs associated with two or more CORESET groups.

In yet another embodiment, a remote unit comprises a receiver that receives scrambled PDSCH(s) scheduled by DCI(s) transmitted from CORESET(s) in a CORESET group; and a processor that descrambles the scrambled PDSCH(s) with a scrambling sequence initialized with a scrambling ID associated with the CORESET group.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 illustrates an example of configuring multiple scrambling IDs according to a first embodiment;

FIG. 2 illustrates an example of configuring multiple scrambling IDs according to a second embodiment;

FIG. 3 is a schematic flow chart diagram illustrating an embodiment of a method for configuring multiple scrambling IDs;

FIG. 4 is a schematic flow chart diagram illustrating a further embodiment of a method for configuring multiple scrambling IDs; and

FIG. 5 is a schematic block diagram illustrating apparatuses according to one embodiment.

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

In Release 15, a UE can only communicate with one TRP. PDSCHs scheduled by DCI(s) transmitted on the time-frequency resources identified by the CORESETs for the one TRP may be scrambled by the sequence initialized by the same scrambling ID. That is, only one scrambling ID is configured for one UE.

It has been agreed that a UE may be configured to have 5 CORESETs per BWP. In addition, a UE may communicate with multiple TRPs, and each TRP may independently transmit DCI(s) to the UE to schedule PDSCHs transmitted from said TRP.

On the other hand, the gNB may configure multiple scrambling IDs for PDSCHs transmitted from different TRPs to whiten the interference between the simultaneously received PDSCHs.

It is desirable to configure the PDSCHs transmitted from different TRPs to be scrambled according to different scrambling IDs. For example, the PDSCHs transmitted from a specific TRP are scrambled according to a scrambling ID associated with the specific TRP.

However, TRP ID may not be explicitly configured. Therefore, it may not be possible to configure a scrambling ID to be directly associated with a TRP based on the TRP ID.

CORESET contains one or more RBs in frequency domain and one or more symbols in the time domain. The time-frequency resources identified by the CORESET may be used to transmit a DCI. The CORESETs may be configured by higher layer signaling to be associated with different TRPs using the additional indices configured for each CORESET. That is, CORESETs for one specific TRP may be configured with the same index value by higher layers from gNB. The index values configured for the CORESETs are traditionally used for the purpose of separating HARQ feedback for different TRPs. Therefore, the CORESETs configured with the same index value are considered as being associated with the same TRP.

According to a first embodiment, the indices of CORESETs may also be used for associating scrambling IDs to CORESETs. That is, the CORESETs with the same index value will be associated with the same scrambling ID. In this manner, each TRP can be associated with a corresponding scrambling ID.

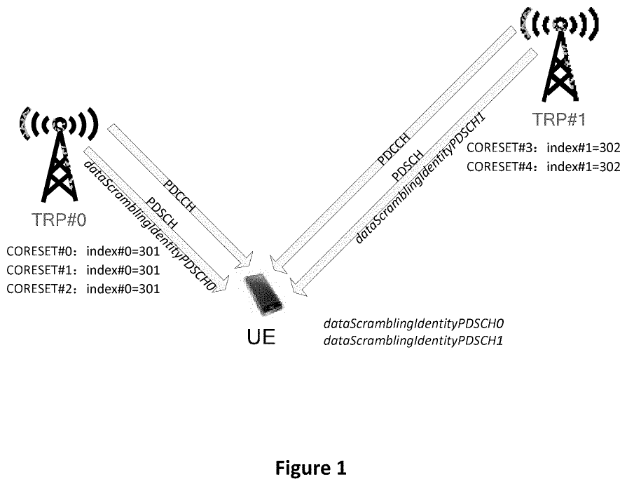

FIG. 1 illustrates an example of configuring scrambling IDs according to the first embodiment.

As shown in FIG. 1, five CORESETs with IDs #0, #1, #2, #3 and #4 are configured for a UE in a BWP (bandwidth part), where index #0=301 is configured for CORESETs #0, #1 and #2 for TRP #0 and index #1=302 is configured for CORESERs #3 and #4 for TRP #1. The same number (as the number of TRPs) of scrambling IDs may be configured.

In FIG. 1, only two TRPs (TRP #0 and TRP #1) are shown. Alternatively, three or more TRPs may be configured, in which each TRP is associated with one or more CORESETs.

For two TRPs illustrated in FIG. 1, two PDSCH scrambling IDs are configured by higher layer signaling as follows:

PDSCH-Config information element

| ---- ASN1START | | | |
|---|---|---|---|
| ---- TAG-PDSCH-CONFIG-START | | | |
| PDSCH-Config ::= | SEQUENCE { | | |
| dataScramblingIdentityPDSCH0 | INTEGER (0..1023) | OPTIONAL, | ---- Need [symbol] |
| dataScramblingIdentityPDSCH1 | INTEGER (0..1023) | OPTIONAL, | ---- Need [symbol] |
| } | | | |

[symbol]

indicates data missing or illegible when filed

According to the first embodiment, the two PDSCH scrambling IDs are associated to with the CORESETs according to the two index values, respectively. For example, the first PDSCH scrambling ID, i.e. dataScramblingIdentityPDSCH0, may be associated with the CORESETs with a lower index value (i.e. CORESETs #0, #1 and #2 that have the index #0. The second PDSCH scrambling ID, i.e. dataScramblingIdentityPDSCH1, may be associated with the CORESETs with a larger index value (i.e. CORESETs #3 and #4 that have the index #1).

Accordingly, PDSCHs scheduled by DCIs transmitted from CORESETs #0, #1 and #2 will be scrambled by the sequence initialized by dataScramblingIdentityPDSCH0 while PDSCHs scheduled by DCIs transmitted from CORESETs #3 and #4 will be scrambled by the sequence initialized by dataScramblingIdentityPDSCH1.

As DCIs transmitted from CORESETs #0, #1 and #2 schedule the PDSCHs transmitted from TRP #0, all of PDSCHs transmitted from TRP #0 would be scrambled by the sequence initialized by dataScramblingIdentityPDSCH0.

Similarly, as DCIs transmitted from CORESETs #3 and #4 schedule the PDSCHs transmitted from TRP #1, all of PDSCHs transmitted from TRP #1 would be scrambled by the sequence initialized by dataScramblingIdentityPDSCH1.

The scrambled PDSCHs are transmitted to the UE. The UE descrambles the received PDSCHs with the same sequence for scrambling the PDSCHs. In particular, the PDSCHs received from TRP #0 (that are scheduled by DCIs transmitted from CORESETS having the index #0) are descrambled with the sequence initialized by dataScramblingIdentityPDSCH0 (which is associated with index #0). The PDSCHs received from TRP #1 (that are scheduled by DCIs transmitted from CORESETS having the index #1) are descrambled with the sequence initialized by dataScramblingIdentityPDSCH1 (which is associated with index #1).

In the first embodiment, multiple index values are configured for the CORESETs. Therefore, the PDSCHs scheduled by DCIs transmitted from different CORESETs may be scrambled respectively by sequences initialized by different scrambling IDs associated with the multiple indices. As the CORESETs from a specific TRP may have the same index, the PDSCHs transmitted from the specific TRP will be scrambled by a sequence initialized by the same scrambling ID corresponding to the specific TRP.

However, instead of CORESETs from different TRPs having different index values, all the configured CORESETs may have the same index value. That is, CORESETs from different TRPs may be configured with the same index value. Furthermore, no index may be configured to CORESETs at all. In this condition, the scrambling ID can NOT be associated with the index values of the CORESETs.

According to a second embodiment, a CORESET group may be introduced to be associated with the scrambling ID.

The CORESET group may be configured by higher layer signaling. Each CORESET group includes one or more CORESETs. Each CORESET group may be associated with a different scrambling ID. The PDSCHs scheduled by DCIs transmitted from CORESETs contained in a CORESET group may be scrambled by a sequence initialized by a scrambling ID associated with the CORESET group.

In particular, the CORESETs contained in one CORESET group may be associated with one TRP. That is, each CORESET group is associated with one TRP.

Each CORESET group may be associated with one scrambling ID. Therefore, each scrambling ID can be associated with one TRP.

Two or more scrambling IDs may be configured to be associated with the same number of CORESET groups.

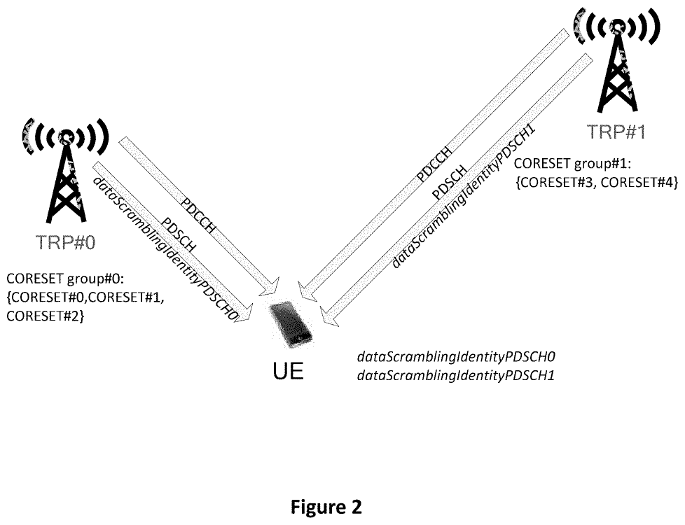

FIG. 2 illustrates an example of configuring scrambling IDs according to the second embodiment.

As shown in FIG. 2, two CORESET groups are configured for one UE. The CORESET group #0 includes CORESETS #0, #1 and #2 for TRP #0. The CORESET group #1 includes CORESETS #3 and #4 for TRP #1.

Two scrambling IDs, i.e. dataScramblingIdentityPDSCH0 and dataScramblingIdentityPDSCH1, may be configured by higher layer signaling. The two scrambling IDs are associated with the two CORESET groups. For example, dataScramblingIdentityPDSCH0 may be associated with CORESET group #0 and dataScramblingIdentityPDSCH1 will be associated with CORESET group #1.

The associated dataScramblingIdentityPDSCH can also be directly configured in the configuration of the CORESET group. That is, when two CORESET groups are configured for the UE, their associated dataScramblingIdentityPDSCH may be configured at the same time.

PDSCHs scheduled by DCIs transmitted from CORESETs contained in the CORESET group #0 may be scrambled by the sequence initialized by dataScramblingIdentityPDSCH0 and PDSCHs scheduled by DCIs transmitted from CORESETs contained in the CORESET group #1 may be scrambled by the sequence initialized by dataScramblingIdentityPDSCH1.

The CORESET group can be defined by using the following higher layer signaling:

ControlResourceSetGroup information element

| | |
|---|---|
| ---- ASN1START | |
| ---- TAG-PDSCH-CONFIG-START | |
| ControlResourceSetGroup ::= | SEQUENCE { |
| controlResourceSetGroupId | ControlResourceSetId, |
| controlResourceSetList | SEQUENCE (SIZE (1..maxNrofcontrolResourceSetPerGroup)) OF |
| ControlResourceSetId | |
| } | |
| ControlResourceSetGroupId ::= | INTEGER (0..maxNrofControlResourceSetGroups-1) |

ControlResourceSetGroup field descriptions
controlResourceSetList
This list contains a list of controlResourceSet IDs belongs to the corresponding group.
maxNrofcontrolResourceSetPerGroup
The maximum number of CORESETs per group.
maxNrofControlResourceSetGroups
The maximum number of CORESET groups configured for one UE.

In FIG. 2, two TRPs and two CORESET groups are illustrated. Alternatively, three or more TRPs and the same number of CORESET groups may be configured. According to the second embodiment, each CORESET group is associated with a scrambling ID. Therefore, each TRP is associated with a scrambling ID. PDSCHs scheduled by DCIs transmitted from CORESETs contained in a CORESET group are scrambled by the sequence initialized by the scrambling ID associated with the CORESET group, i.e. with the TRP for the CORESET group.

The scrambled PDSCHs are transmitted to the UE. The UE descrambled the received PDSCHs with the same sequence for scrambling the PDSCHs. In particular, the PDSCHs received from TRP #0 are descrambled with the sequence initialized by dataScramblingIdentityPDSCH0 (which is associated with CORESET group #0). The PDSCHs received from TRP #1 are descrambled with the sequence initialized by dataScramblingIdentityPDSCH1 (which is associated with CORESET group #1).

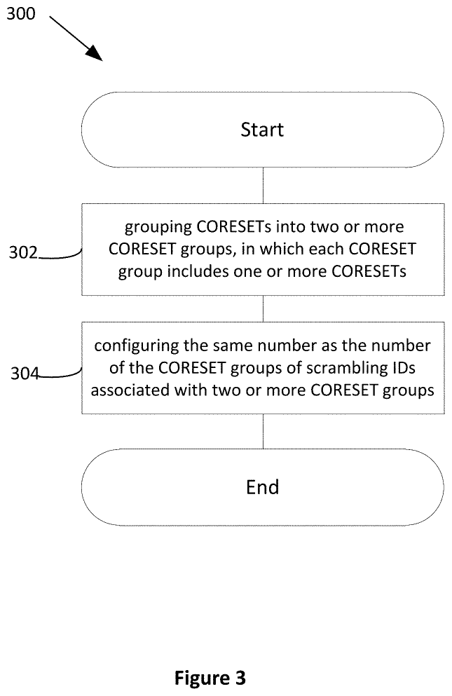

FIG. 3 is a schematic flow chart diagram illustrating an embodiment of a method 300 for configuring multiple scrambling IDs. In some embodiments, the method 300 is performed by an apparatus, such as a base unit. In certain embodiments, the method 300 may be performed by a processor executing program code, for example, a microcontroller, a microprocessor, a CPU, a GPU, an auxiliary processing unit, a FPGA, or the like.

The method 300 may include 302 grouping CORESETs into two or more CORESET groups, in which each CORESET group includes one or more CORESETs; and 304 configuring the same number as the number of the CORESET groups of scrambling IDs associated with two or more CORESET groups. The method 300 may further include step of scrambling PDSCH(s) scheduled by DCI(s) transmitted in the CORESETs in a CORESET group with a scrambling sequence initialized with the scrambling ID associated with the CORESET group, and step of transmitting the scrambled PDSCH(s).

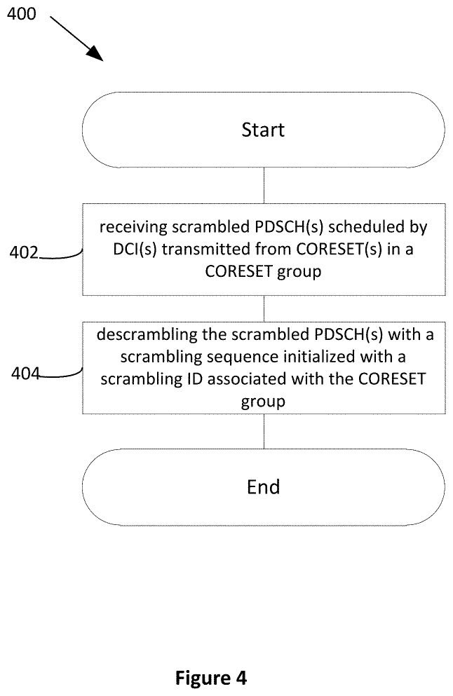

FIG. 4 is a schematic flow chart diagram illustrating an embodiment of a method 400 for configuring multiple scrambling IDs. In some embodiments, the method 400 is performed by an apparatus, such as a remote unit (UE). In certain embodiments, the method 400 may be performed by a processor executing program code, for example, a microcontroller, a microprocessor, a CPU, a GPU, an auxiliary processing unit, a FPGA, or the like.

The method 400 may include 402 receiving scrambled PDSCH(s) scheduled by DCI(s) transmitted from CORESET(s) in a CORESET group; and 404 descrambling the scrambled PDSCH(s) with a scrambling sequence initialized with a scrambling ID associated with the CORESET group.

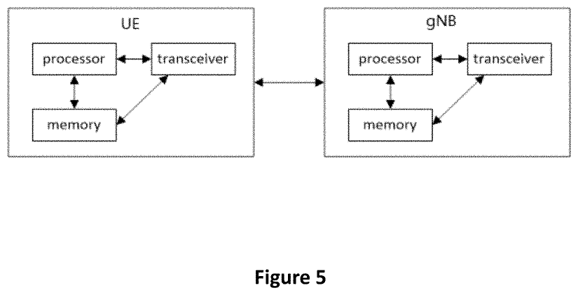

FIG. 5 is a schematic block diagram illustrating apparatuses according to one embodiment.

Referring to FIG. 5, the UE (i.e. the remote unit) includes a processor, a memory, and a transceiver. The processor implements a function, a process, and/or a method which are proposed in FIG. 4. The gNB (i.e. base unit) includes a processor, a memory, and a transceiver. The processors implement a function, a process, and/or a method which are proposed in FIG. 3. Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated by the appended claims rather than by the foregoing description. All changes which come within the meaning and range of equivalency of the claims are to be embraced within their scope.

1-16. (canceled)

17. An apparatus comprising:
one or more processors configured to:
group control resource sets into two or more control resource set groups, each control resource set group including one or more control resource sets; and
configure a same number of scrambling identifiers as a number of control resource set groups of the two or more control resource set groups.

18. The apparatus of claim 17, wherein control resource sets having a same index value are grouped into a same control resource set group.

19. The apparatus of claim 17, wherein control resource sets transmitted from a same transmission reception point are grouped into a same control resource set group.

20. The apparatus of claim 17, wherein control resource sets transmitted from a same transmission reception point are grouped into a same control resource set group, and wherein the same transmission reception point is associated with a single scrambling identifier.

21. The apparatus of claim 17, the one or more processors are further configured to configure a first scrambling identifier for a first control resource set group of the two or more control resource set groups, and configure a second, different scrambling identifier for a second control resource set group of the two or more control resource set groups.

22. The apparatus of claim 17, wherein the one or more processors are further configured to scramble one or more physical downlink shared channels scheduled by downlink control information transmitted in the control resource sets in a control resource set group with a scrambling sequence initialized with a scrambling identifier associated with the control resource set group.

23. The apparatus of claim 22, further comprising a transceiver configured to transmit the scrambled one or more physical downlink shared channels.

24. The apparatus of claim 22, wherein the scrambling identifier is associated with a single transmission reception point.

25. An apparatus comprising:
a transceiver configured to receive one or more scrambled physical downlink shared channels scheduled by downlink control information transmitted from one or more control resource sets in a control resource set group; and
one or more processors configured to descramble the one or more scrambled physical downlink shared channels with a scrambling sequence initialized with a scrambling identifier associated with the control resource set group.

26. The apparatus of claim 25, wherein the one or more control resource sets in the control resource set group have a same index value.

27. The apparatus of claim 25, wherein the one or more control resource sets in the control resource set group are associated with a same transmission reception point.

28. The apparatus of claim 27, wherein the scrambling identifier is associated with the same transmission reception point.

29. A method comprising:
grouping control resource sets into two or more control resource set groups, each control resource set group including one or more control resource sets; and
configuring a same number of scrambling identifiers as a number of control resource set groups of the two or more control resource set groups.

30. The method of claim 29, wherein control resource sets having a same index value are grouped into a same control resource set group.

31. The method of claim 29, wherein control resource sets transmitted from a same transmission reception point are grouped into a same control resource set group.

32. The method of claim 29, further comprising configuring a first scrambling identifier for a first control resource set group of the two or more control resource set groups, and configuring a second, different scrambling identifier for a second control resource set group of the two or more control resource set groups.

33. The method of claim 29, wherein control resource sets transmitted from a same transmission reception point are grouped into a same control resource set group, and wherein the same transmission reception point is associated with a single scrambling identifier.

34. The method of claim 29, further comprising scrambling one or more physical downlink shared channels scheduled by downlink control information transmitted in the control resource sets in a control resource set group with a scrambling sequence initialized with a scrambling identifier associated with the control resource set group.

35. The method of claim 34, wherein the scrambling identifier is associated with a single transmission reception point.

36. The method of claim 34, further comprising transmitting the scrambled one or more physical downlink shared channels.
